(19) United States
(12) Patent Application Publication
(10) Pub. No.: US 2026/0021468 A1
(43) Pub. Date: Jan. 22, 2026

(54) METHOD FOR PREPARING A FUNCTIONALISED GEOPOLYMER INVOLVING 3D PRINTING, SAID GEOPOLYMER AND ITS USES

(71) Applicant: COMMISSARIAT A L'ENERGIE ATOMIQUE ET AUX ENERGIES ALTERNATIVES, Paris (FR)

(72) Inventors: David LAMBERTIN, Orange (FR); Antoine LEYDIER, Tresques (FR); Matthieu DE CAMPOS, Loison-Sous-Lens (FR); Charles REEB, Woustviller (FR)

(73) Assignee: COMMISSARIAT A L'ENERGIE ATOMIQUE ET AUX ENERGIES ALTERNATIVES, Paris (FR)

(21) Appl. No.: 18/997,974

(22) PCT Filed: Jul. 20, 2023
(86) PCT No.: PCT/FR2023/051129

§ 371 Date: Jan. 23, 2025

(30) Foreign Application Priority Data
Jul. 25, 2022 (FR) 2207634

(51) Int. Cl. B01J 20/22; B01D 53/82; B01J 20/28; B01J 20/30; B01J 20/32; C02F 1/28; C02F 101/10; C02F 101/20; C02F 103/00; C02F 103/08

(52) U.S. Cl. CPC B01J 20/22; B01D 53/82; B01J 20/28045; B01J 20/3007; B01J 20/3204; B01J 20/3219; B01J 20/3259; C02F 1/285; B01D 2258/06; C02F 2101/103; C02F 2101/20; C02F 2103/007; C02F 2103/08

(57) ABSTRACT

A method for preparing a geopolymer capable of trapping at least one ion, may include, firstly, preparing a geopolymer including at least one 3D printing, then functionalizing the geopolymer thus prepared by at least one extractant group, the group not including an —NH₂ amine function. Such a functionalized geopolymer thus prepared may be used to separate at least one ion from a flow containing the at least one ion.

### TECHNICAL FIELD

The present invention belongs to the field of geopolymers and in particular the geopolymers useful for the depollution, the purification and/or the decontamination of liquid or gaseous effluents as well as for filtration.

Indeed, the present invention proposes a method allowing to prepare a geopolymer capable of trapping at least one element of interest of the ion type via the covalent grafting of one or more extractant groups, identical or different. Moreover, this method includes a 3D printing step by means of which a geopolymer with an optimised open porosity and thus a significant specific surface area is obtained, which allows to increase the number of extractant groups grafted.

The present invention also relates to a geopolymer thus prepared and its various uses in particular in any field requiring the selective trapping or the selective extraction of elements of interest of the ion type.

### PRIOR ART

Geopolymers are aluminosilicate materials synthesised from the alkaline activation of an aluminosilicate source such as, for example, metakaolin or fly ash. They are mainly amorphous materials that have an intrinsic porosity of approximately 40-50%, with an average pore size between 4 and 15 nm and a specific surface area between 40 and 200 m²/g according to the alkaline activator used i.e. sodium or potassium [1].

Geopolymers are presented as having good mechanical strength, good resistance to fire and to acid attacks. In fact, they can be used in various industrial sectors like (i) construction as a construction or insulation material, (ii) the nuclear industry for the conditioning of waste or (iii) chemistry as a catalyst support or filtration membrane or for the trapping of toxic elements or other heavy metals.

With regard to the latter aspect, geopolymers are in particular used to capture caesium. The works of Lee et al (2017) have shown the adsorption of caesium in solution on a mesoporous geopolymer [2]. It was possible to show a recovery efficiency of 96%, maximum adsorption was reached with 15.24 mg/g of geopolymer, which is less than pulverised mordenite (zeolite). Only three parameters were studied: the initial concentration of caesium, the pH of the caesium solution and the time of contact of the geopolymer with this solution.

Since 2009, 3D printing has been constantly improving and innovating in numerous fields. The main advantage of 3D printing is the toll manufacturing of more or less complex parts, meeting the specifications of the future use. The 3D printing of geopolymers has been described in the prior art.

The works carried out by Luukkonen et al (2020) compare the effectiveness of various filtration membranes made of modified geopolymer i.e. geopolymer incorporating either silver or copper for the filtration of water [3]. Various synthesis pathways have been studied: 3D printing of the additive manufacturing type, i.e. manufacturing of parts with a complex and controlled geometry, direct foaming and granulation. The geopolymers obtained by 3D printing of the specific formulation implemented in [3] have, after curing at 60° C. for 4h, the lowest total porosity (28% in the first layers) and the lowest specific surface area (6 m²/g).

Cepollaro et al (2020) have shown the possibility of manufacturing a 3D-printable geopolymer allowing the selective reduction of gaseous nitrogen oxides (NOx) which are pollutants emitted by combustion engines [4]. To resolve this issue, the geopolymer incorporates zeolites (37% by weight of ZSM-5), and is functionalised by an ion exchange (copper ion) via a solution of copper acetate. The geopolymer formulation used allows the creation of mesopores after acid treatment. However, these works show that the incorporation of the copper is not optimal, since the latter is found in the form of copper hydroxide which is non-reactive for the selective catalytic reduction of the NOx.

The inventors set the goal of proposing a method that is easy to implement to prepare a geopolymer allowing to effectively trap at least one element of interest of the ion type in particular with a view to generating a filtration membrane or with a view to decontaminating a liquid or gaseous effluent of toxic elements or other heavy metals.

### DISCLOSURE OF THE INVENTION

The present invention allows to reach the goal set by the inventors by providing a method allowing to prepare, in a simple and easy-to-implement manner, a geopolymer capable of effectively trapping at least one ion such as a metal or metalloid ion, this material not having the disadvantages of the materials of the prior art.

More particularly, the inventors have shown that it is possible to solve the technical problems of the materials of the prior art by combining the preparation of a geopolymer involving at least one step of 3D printing with the functionalisation of the geopolymer thus prepared with at least one extractant group capable of trapping, chelating and/or complexing at least one ion such as a metal or metalloid ion.

Indeed, both additive (or direct) 3D printing and inverse 3D printing i.e. with a sacrificial support (or backbone), also known by the term “template”, offer numerous advantages and in particular allow to obtain a geopolymer having a high specific surface area of approximately several tens of m²/g, which means a significant surface area and thus a significant number of reactive functions for the later grafting of extractant groups. Such a specific surface area can be obtained by increasing the printing density via a reduction in the printing resolution (order of magnitude going from a millimetre to a hundred micrometres) with much weaker macroporosities (from several micrometres to several hundred nanometres). Moreover, the geopolymer or the sacrificial support prepared by 3D printing can have complex shapes for which an increase in the tortuosity by change in the printing geometry also allows to obtain a high specific surface area.

Moreover, direct 3D printing allows to prepare a geopolymer having, besides mesopores and optionally non-connected macropores resulting mainly from the geopolymerisation method, connected macropores obtained via the 3D printing.

Likewise, in the context of inverse 3D printing with a sacrificial support immersed in a geopolymer mixture or grout, the elimination of the latter, once the geopolymer has hardened, allows to open the macroporosity of the latter and, therefore, to reach low resolutions in terms of size of the macropores.

Thus, the geopolymer obtained by the method of the invention can be in the form of a geopolymer foam without it being necessary to add, to the geopolymer mixture or to the geopolymer grout, pore-forming materials. The latter could require, to be eliminated from the geopolymer, treatments that can alter, physically and/or chemically, the latter. It is however possible to use, in the context of the present invention, pore-forming materials that do not require an elimination or the elimination of which is carried out via a treatment that does not alter, either physically or chemically, the geopolymer.

Finally, the inventors have shown that it is possible to obtain a geopolymer without it being necessary to subject this material to a step of drying at high temperature to free the porosity thereof. Indeed, the inventors have more particularly shown that subjecting the geopolymer grout to 3D printing allows to eliminate the need for any heat treatment. This advantage i.e. absence of a step at high temperature also applies when the geopolymer is obtained by using a sacrificial support prepared by 3D printing. It should be noted however that, in the context of inverse 3D printing, a high temperature i.e. greater than 30° C. can be necessary when the step of freeing the porosity by elimination of the sacrificial support and the step of functionalisation by extractant groups are concomitant.

Thus, the present invention relates to a method for preparing a geopolymer capable of trapping at least one ion, comprising:
the preparation of a geopolymer, which preparation comprises at least one step during which 3D printing is used; and
the functionalisation of the geopolymer thus prepared by at least one extractant group specific to said at least one ion.

Advantageously, in the method according to the invention, the extractant group does not comprise an —NH₂ amine function.

“Geopolymer” means, in the context of the present invention, a solid and porous material in the dry state, obtained after the hardening of a mixture containing finely ground materials (i.e. the aluminosilicate source) and a saline solution (i.e. the activation solution), said mixture being capable of setting and hardening over time. This mixture can also be designated by the terms “geopolymeric mixture”, “geopolymer mixture”, “geopolymeric composition” or “geopolymer composition”. The hardening of the geopolymer is the result of the dissolution/polycondensation of the finely ground materials of the geopolymer mixture in the saline solution such as a saline solution having a high pH (i.e. the activation solution).

More particularly, a geopolymer is an amorphous aluminosilicate inorganic polymer. Said polymer is obtained from a reactive material substantially containing silica and aluminium (i.e. the aluminosilicate source), activated by a strongly alkaline solution, the solid/solution mass ratio in the formulation being low. The structure of a geopolymer is composed of an Si-O-Al network formed by tetrahedrons of silicates (SiO₄) and of aluminates (AlO₄) bound at their vertices by sharing of oxygen atoms. Inside this network, there are one or more charge-compensating cations also called compensation cations that allow to compensate for the negative charge of the AlO₄ complex. Said compensation cation(s) are advantageously chosen from the group consisting of the alkali metals such as lithium (Li), sodium (Na), potassium (K), rubidium (Rb) and caesium (Cs); the alkaline earth metals such as magnesium (Mg), calcium (Ca), strontium (Sr) and barium (Ba); and the mixtures thereof.

The expressions “reactive material substantially containing silica and aluminium” and “aluminosilicate source” are, in the present invention, similar and usable interchangeably.

The reactive material substantially containing silica and aluminium usable to prepare the geopolymer matrix implemented in the context of the invention is advantageously a solid source containing amorphous aluminosilicates. These amorphous aluminosilicates are in particular chosen from the minerals of natural aluminosilicates such as illite, stilbite, kaolinite, pyrophyllite, andalusite, bentonite, kyanite, milanite, grovenite, amesite, cordierite, feldspar, allophane, etc.; calcined minerals of natural aluminosilicates such as metakaolin; synthetic glasses containing pure aluminosilicates; aluminous cement; pumice; calcined byproducts or residues of industrial use such as fly ash and blast-furnace slag respectively obtained from the combustion of coal and during the transformation of iron ore into cast iron in a blast furnace; and mixtures thereof.

The saline solution having a high pH also known, in the field of geopolymerisation, as “activation solution” is a strongly alkaline aqueous solution that can optionally contain silicate components in particular chosen from the group consisting of silica, colloidal silica and vitreous silica.

The expressions “activation solution”, “saline solution having a high pH” and “strongly alkaline solution” are, in the present invention, similar and usable interchangeably.

“Strongly alkaline” or “having a high pH” means a solution, the pH of which is greater than 9, notably greater than 10, in particular, greater than 11 and more particularly greater than 12. In other words, the activation solution has a concentration of OH greater than 0.01 M, notably greater than 0.1 M, in particular greater than 1 M and, more particularly, between 5 and 20 M.

Moreover, the activation solution comprises the compensation cation or the mixture of compensation cations in the form of an ionic solution or of a salt. Thus, the activation solution is in particular chosen from an aqueous solution of sodium silicate (Na₂SiO₃), of potassium silicate (K₂SiO₂), of sodium hydroxide (NaOH), of potassium hydroxide (KOH), of calcium hydroxide (Ca(OH)₂), of caesium hydroxide (CsOH) and their derivatives, etc.

A geopolymer has a mesoporous intrinsic porosity of approximately 10 to 20% by volume relative to the total volume of the geopolymer, the latter also being capable of having non-connected macropores. In other words, a geopolymer has, because of its preparation method, connected mesopores and optionally non-connected macropores. However, it is possible to prepare a mesoporous and macroporous geopolymer, with connected macropores, via the step of 3D printing, direct or inverse with a sacrificial support. In this case, this is called a geopolymer foam. “Mesopores” means pores or spaces having an average diameter between 2 and 50 nm and in particular between 2 and 20 nm. “Macropores” means pores or spaces having an average diameter greater than 50 nm and in particular greater than 70 nm. In a geopolymer foam, the total porosity corresponding to the macroporosity and the mesoporosity is greater than 70%, in particular greater than 75% and, in particular, greater than 80% by volume relative to the total volume of the geopolymer foam.

In the context of the present invention, the geopolymer can be either a mesoporous geopolymer with optionally non-connected macropores or a geopolymer foam i.e. a mesoporous and macroporous geopolymer, the macropores being connected. In these two alternatives, the extractant group(s) are present at the surface and in particular at the surface of the pores or voids of the mesoporous geopolymer with optionally non-connected macropores or of the geopolymer foam.

As explained above, the geopolymer prepared by the method according to the invention is capable of trapping one or more ions via the specific extractant groups of this or these ions that are grafted at its surface.

An extractant group is also known, in the prior art, by the expression “chelating group” or “complexing group”. This is a group capable of trapping, chelating and/or complexing one or more ions and in particular one or more metal or metalloid ions. Any organic extractant group known from the prior art is usable in the context of the present invention.

Illustrative and non-limiting examples of such extractant groups include:
an ammonium function having the formula —N⁺(R₁)(R₂)(R₃) with R₁, R₂ and R₃, identical or different, representing a hydrogen atom, an alkyl radical or an aryl radical;
an amine function having the formula —N(R₄)(R₅) with R₄, and R₅, identical or different, representing a hydrogen atom, an alkyl radical or an aryl radical provided that, when R₄ represents a hydrogen atom, R₅ does not represent a hydrogen atom;
an amide function having the formula —C(═O)—N(R₆)(R₇) or —N(R₆)C(═O)-(R₇) with R₆ and R₇, identical or different, representing a hydrogen atom, an alkyl radical or an aryl radical;
a phosphorus function having the formula -X₂-P(=X₁)ₙ(X₃R₈)(X₄R₉) with n representing 0 or 1, X₁ representing an oxygen atom or a sulphur atom, X₂, X₃ and X₄, identical or different, representing a chemical bond, an oxygen atom, a sulphur atom or a —CR₁₀R₁₁- group, R₈ and R₉, identical or different, representing a hydrogen atom, an alkyl radical or an aryl radical and R₁₀ and R₁₁, identical or different, representing a hydrogen atom or an alkyl radical; such a phosphorus function covers the functions ranging from a phosphonate function to phosphine oxide and their mono- or di-thiolated equivalents;

a diglycolamide function having the formula —N(R₁₂)—C(═O)—CH₂—O—CH₂—C(═O)—N(R₁₃)(R₁₄) with R₁₂, R₁₃ and R₁₄, identical or different, representing an alkyl radical or an aryl radical;
an amine or polyamine function with acetic acid groups having the formula -[N(CH₂COOH)-C₂H₄]ₘ—N(CH₂-COOH)₂ with m representing 0 or an integer in particular chosen from the group consisting of 1, 2, 3 and 4;
a sulphonic acid function -(CH₂)ₚ(SO₃H) with p representing 0 or an integer in particular chosen from the group consisting of 1, 2, 3, 4 and 5;
a urea function having the formula —NR₁₅—C(═O)—N(R₁₆)(R₁₇) with R₁₅, R₁₆ and R₁₇, identical or different, representing a hydrogen atom, an alkyl radical or an aryl radical;
a function of the macromolecular type or a polydentate function such as a crown ether, a thioether crown, a calixarene, a porphyrin, a phthalocyanine, a pyrazoline, a phenanthroline, an ethylenediaminetriacetic acid, an ethylenediaminetetraacetic acid (EDTA), a 1,4,7,10-tetraazacyclododecane-1,4,7,10-tetraacetate (DOTA) and a diethylene triamine pentaacetate (DTPA); and
any combination of the latter.

In the case of an extractant group of the type amine function having the formula —N(R₄) (R₅), R₄, and R₅, identical or different, advantageously represent an alkyl radical or an aryl radical.

“Combination” means, in the present invention, the combination of at least two functions, identical or different, chosen from the aforementioned functions. These functions can be bound to one another or substitute the same atom or different atoms in a hydrocarbon chain. Specific examples of such combinations include a polyethyleneimine function, an amido-thio-phosphonate function, an aminosulphate function or an amino-phosphate function having the formula —NH-CR₁₈R₁₉-P(═O)(X₅R₂₀)(X₆R₂₁) with R₁₈ and R₁₉, identical or different, representing a hydrogen atom or alkyl radical, X₅ and X₆, identical or different, representing a chemical bond or an oxygen atom and R₂₀ and R₂₁, identical or different, representing an alkyl radical or an aryl radical.

“Alkyl radical” (or Alk) means, in the context of the present invention, an alkyl radical, linear, branched or cyclic, comprising from 1 to 15 carbon atoms, notably from 1 to 12 carbon atoms and, in particular, from 1 to 8 carbon atoms, wherein said alkyl radical can optionally comprise at least one heteroatom and/or at least one double or triple carbon-carbon bond. The alkyl radical can also be substituted.

“Heteroatom” means, in the context of the present invention, an atom chosen from the group consisting of a nitrogen, an oxygen, a phosphorus, a sulphur, a silicon, a fluorine, a chlorine and a bromine.

“Aryl radical” means, in the context of the present invention, any radical comprising an aromatic cycle or several aromatic cycles, identical or different, bound or connected by a simple bond or by a hydrocarbon chain, an aromatic cycle having from 3 to 20 carbon atoms, notably from 4 to 14 carbon atoms and, in particular, from 5 to 8 carbon atoms and optionally being capable of comprising a heteroatom. The aryl radical can also be substituted.

“Substituted alkyl/aryl radical” means, in the context of the present invention, an alkyl/aryl radical as defined above substituted by a group or several groups, identical or different, chosen from the group consisting of a halogen; an amine; a diamine; a carboxyl; a carboxylate; an aldehyde; an ester; an ether; a thioether; a ketone; a hydroxyl; an optionally substituted alkyl; an amide; a sulphonyl; a sulphoxide; a sulphonic acid; a sulphonate; a nitrile; a nitro; an acyl; an epoxy; a phosphonate; an isocyanate; a thiol; a glycidoxy and an acryloxy.

“Halogen” means, in the context of the present invention, an atom chosen from the group consisting of an iodine, a fluorine, a chlorine and a bromine.

In the context of the invention, the functionalisation of the geopolymer by at least one extractant group implements at least one covalent chemical bond. Thus, the extractant groups are attached, grafted or immobilised, covalently, at the surface of a geopolymer and in particular at the surface of the mesopores and of the macropores of the latter.

In the context of the present invention, the attachment, the grafting or the immobilisation of the extractant group(s) at the surface of the geopolymer can be direct or indirect. Thus, the functionalisation of the geopolymer by at least one extractant group can be direct. Alternatively, the functionalisation of the geopolymer by at least one extractant group can be indirect.

When it is direct, the covalent chemical bond implemented involves an atom present at the surface of the geopolymer and an atom of the extractant group.

When the attachment is indirect, the attachment, the grafting or the immobilisation involves a connector also designated by the expression “binding arm” or “junction agent” bound, on the one hand, to the surface of the geopolymer and, on the other hand, to the extractant group. The bonds implemented are advantageously covalent bonds. The connector compiles two functionalities, one involves giving mobility to the structure and notably to the extractant group (carbon chemistry of the type polyethylene glycol (PEG), alkylene chain, polyethylene terephthalate (PET), etc.), the other involves attaching, to the geopolymer, the extractant group. Typically, the connector implemented in the context of the present invention is an alkylene chain.

“Alkylene chain” means, in the context of the present invention, an alkylene chain, linear, branched or cyclic, comprising from 1 to 30 carbon atoms, notably from 1 to 20 carbon atoms and, in particular, from 1 to 15 carbon atoms, wherein said alkylene chain can optionally comprise at least one heteroatom.

In order to facilitate the covalent chemical bond between the extractant group and the surface of the geopolymer in the case of a direct functionalisation, the extractant group and the surface of the geopolymer carry or are substituted, both, by at least one reactive function, identical or different. When a connector is implemented, the latter carries the reactive function capable of reacting with the reactive function, identical or different, present at the surface of the geopolymer.

These reactive functions are in particular chosen from the group consisting of a silane function, a silanol function, an amine function, a thiol function, an aldehyde function, an allyl function, an epoxy function, an alkoxysilane function having the formula —Si(OR₂₂)(OR₂₃)(OR₂₄) with R₂₂, R₂₃ and R₂₄, identical or different, representing an alkyl radical as defined above and in particular a methyl (Me) or an ethyl (Et).

In a first embodiment of the preparation of the geopolymer, the geopolymer mixture or grout is subjected to 3D printing. Thus, the preparation of the geopolymer comprises the steps of:
a1) preparing a geopolymer mixture;
b1) subjecting said geopolymer mixture prepared in step a₁) to 3D printing; and
c₁) allowing said geopolymer mixture printed in step b₁) harden whereby a geopolymer is obtained.

Step a₁) of the method according to the present invention involves adding to an activation solution as defined above, previously prepared, at least one aluminosilicate source as defined above. This step and the previous preparation of the activation solution are conventional steps in the field of geopolymers.

As explained above, the activation solution can optionally contain one or more silicate components in particular chosen from the group consisting of silica, colloidal silica and vitreous silica. When the activation solution contains one or more silicate components, the latter are present in a quantity between 100 mM and 10 M, notably between 500 mM and 8 M and, in particular, between 1 and 6 M in the activation solution.

The aluminosilicate source(s) are added to the activation solution all at once or in batches. Once the aluminosilicate source(s) have been added to the activation solution, the solution or dispersion obtained is mixed by using a mixer, a magnetic stirrer, a magnetic stirring bar, an ultrasound bath or a homogeniser. The mixing/stirring during the substep i) of the method according to the invention is carried out at a high speed. “High speed” means, in the context of the present invention, a speed of rotation of the rotor of the mixer or of the magnetic stirrer greater than or equal to 1000 rpm, notably greater than or equal to 1500 rpm and, in particular, greater than or equal to 2000 rpm. Advantageously, this stirring is carried out by using a magnetic stirrer or a mixer. Any mixer known to a person skilled in the art is usable in the context of the present invention. Non-limiting examples include a NAUTA® mixer, a HOBART® mixer, a HENSCHEL® mixer and a HEIDOLPH® mixer.

Taking into account the possible silicate components that the activation solution can contain, the quantity of aluminosilicate source(s) is such that the SiO₂/Al₂O₃ molar ratio in the final geopolymer is between 3.2 and 4.2, notably between 3.4 and 4.0 and, in particular, approximately 3.8 (i.e. 3.8±0.1).

Moreover, the activation solution/MK mass ratio with activation solution representing the mass of activation solution (expressed in g) and MK representing the mass of aluminosilicate source (expressed in g) used is advantageously between 0.9 and 1.8 and in particular between 1.2 and 1.5. As a specific example, the activation solution/MK ratio is approximately 1.36 (i.e. 1.36±0.10).

It may be necessary to increase the viscosity of the geopolymer mixture implemented during direct 3D printing. For this purpose, a viscosifying agent can be added to this mixture. Any viscosifying agent, organic or not, known to a person skilled in the art can be used. Specific examples of such viscosifying agents include fines or surfactants.

The fines also called “fillers” or “additive fines” are a dry product, finely divided, coming from the cutting, sawing or the working of natural rocks, aggregates and ornamental stones. Advantageously, the fines have an average grain size in particular between 5 and 200 μm.

The surfactants usable to increase the viscosity of the geopolymer mixture are in particular chosen from the anionic surfactants, the cationic surfactants, the zwitterionic surfactants, the amphoteric surfactants, and the neutral (non-ionic) surfactants. More particularly, the surfactants usable to increase the viscosity of the geopolymer mixture are chosen from the cationic surfactants like, for example, cetyltrimethylammonium bromide (CTAB).

The quantity of viscosifying agent(s) used in the context of the present invention depends greatly on the viscosity desired for the geopolymer mixture. A person skilled in the art will be able to determine the suitable quantity via routine trials. For example, the viscosifying agent(s) are present in a proportion between 0.1 and 20%, notably between 0.5 and 15% and, in particular, between 1 and 10% by weight relative to the total weight of the geopolymer mixture.

Step a₁) of the method according to the invention is carried out at a temperature between 10° C. and 40° C., advantageously between 15° C. and 30° C. and, more particularly, at ambient temperature (i.e. 23° C.±5° C.) for a duration greater than 2 min, notably between 4 min and 1 h and, in particular, between 5 min and 15 min.

In a first specific embodiment, the geopolymer mixture prepared in step a₁) comprises a pore-forming material as defined above.

In a second specific embodiment, the geopolymer mixture prepared in step a₁) does not comprise any pore-forming material.

In a third specific embodiment, the geopolymer mixture prepared in step a₁) does not comprise a zeolite.

In a fourth specific embodiment, the geopolymer mixture prepared in step a₁) comprise neither pore-forming material nor zeolite.

Step b₁) of the method according to the present invention involves subjecting the geopolymer mixture obtained in step a₁) to 3D printing. The latter allows to confer a given shape onto the geopolymer and in particular to have a geopolymer of the geopolymer foam type and/or in the form of a filter.

Any equipment usable for 3D printing is usable in the context of the present invention. Illustrative examples include the 3D printers from the following suppliers: VormVrij, StoneFlower, Lynxter, 3D Potter and WASP.

Step c1) of the method according to the invention involves subjecting the geopolymer mixture printed after step b₁) to conditions allowing its hardening.

Any technique known to a person skilled in the art to harden a geopolymer mixture is usable during the hardening step of the method.

The conditions allowing the hardening during step c₁) advantageously comprise a step of curing that can take place in open air or under water. This curing step is advantageously implemented at a temperature lower than 30° C. and in particular at ambient temperature and can last between 18 h and 20 days, notably between 24 h and 16 days and, in particular, approximately 14 days (i.e. 14 days±1 day).

Finally, as explained above, no heat treatment i.e. a heat treatment at a temperature greater than or equal to 30° C. must be applied to the material after this curing step, to free its porosity.

In a specific embodiment, all of steps a₁), b₁) and c₁) of the preparation of the geopolymer are carried out at ambient temperature.

In a second embodiment of the preparation of the geopolymer, the geopolymer mixture or grout is placed in contact with a sacrificial support obtained by 3D printing. Thus, the preparation of the geopolymer comprises the steps of:
a₂) preparing, by 3D printing, a sacrificial support;
b₂) placing said sacrificial support prepared in step a₂) in contact with a previously prepared geopolymer mixture;
c₂) allowing said geopolymer mixture harden in contact with said sacrificial support; and
d₂) eliminating said sacrificial support whereby a geopolymer is obtained.

Step a₂) of the preparation of the geopolymer involves printing the sacrificial support on a fused deposition modelling 3D printer (FDM type), the filament chosen can be of various chemical natures. However, the latter must be able to be dissolved by simple immersion in a solvent like an organic solvent. The printing parameters such as the outlet temperature of the nozzle and of the bed are chosen according to the chemical nature of the filament.

It is clear that the sacrificial support is of the same chemical nature as the filament implemented. Advantageously, the latter is an organic polymer. Specific examples of filaments usable during step a₂) of the method include a filament made of polystyrene like high-impact polystyrene (or HIPS), made of water-soluble polyethylene oxide, made of nylon, made of polylactic acid (PLA), made of polycarbonate, made of polyurethane (PLU), made of polyacrylonitrile or made of poly (acrylonitrile/butadiene/styrene) (ABS).

Everything described above for the preparation of the geopolymer mixture during step a₁) applies to the preparation of the geopolymer mixture during step b₂)

It should be noted however that inverse 3D printing allows the use of a geopolymer mixture, the values of the viscosity of which can be more variable than those of the viscosity of the geopolymer mixture used for the direct 3D printing. Thus, the viscosity of the geopolymer mixture used for the inverse 3D printing is between 1 Pa·s and 200 Pa·s, at a shear rate of 0.1 s⁻¹, while that of the geopolymer mixture used for the direct 3D printing can be greater than 1000 Pa·s, at a shear rate of 0.1 s⁻¹.

Step b₂) thus involves immersing or submerging the sacrificial support in the geopolymer mixture or pouring this mixture onto the sacrificial support. After this immersion, it may be necessary to eliminate the residual bubbles of air present in the geopolymer mixture by subjecting the assembly (geopolymer mixture+sacrificial support) to the action of ultrasounds. This treatment can be carried out for a duration between 15 s and 1 min and, in particular, of approximately 30 s (30 s±5 s).

Everything described above for step c₁) applies mutatis mutandis to step c₂). Finally, step d₂) involves freeing the porosity of the geopolymer by dissolution of the polymer sacrificial support present in the material obtained after step c₂). For this, the mixture is immersed in a solvent capable of dissolving the sacrificial support under stirring and maintained thus until stabilisation of its mass. The geopolymer thus prepared has a controlled porosity.

Examples of solvents usable during step d₂) include water, ethyl acetate, acetone, ethanol, isopropanol, tetrahydrofuran (THF), dioxane or dichloromethane.

The elimination of the sacrificial support in step d₂) and the functionalisation by one or more extractant groups of the geopolymer during step i) as defined below can be carried out concomitantly. The conditions implemented corresponding to the conditions of step i) as defined below.

Once the sacrificial support has been eliminated, the geopolymer can be dried under air or in an oven, in particular at a temperature lower than 30° C. It should be noted however that this drying step is optional.

It may be necessary, before step d₂), to prepare the surface of the material obtained after step c₂) in order to expose the surface of the sacrificial support.

Indeed, the material obtained after step c₂) can be in the form of a geopolymer inside of which the sacrificial support is trapped. This preparation is typically carried out by mechanical cutting by using, for example, a circular or wire saw or a chainsaw with a diamond disk.

In the method according to the invention, regardless of the embodiment of the preparation of the geopolymer, the latter is then functionalised by one or more extractant groups, identical or different, as defined above.

This functionalisation advantageously comprises the steps of:
i) placing the geopolymer in contact with a molecule comprising at least one extractant group and at least one reactive function as defined above in conditions allowing the formation of at least one covalent bond between said molecule and said geopolymer; and
ii) eliminating said molecule that has not reacted with said geopolymer during step i), whereby a geopolymer functionalised by at least one extractant group is obtained.

The molecule implemented during step i) can comprise at least one reactive function directly bound to the extractant group. This is the case of a direct functionalisation.

Alternatively, in the case of an indirect functionalisation, the molecule implemented during step i) can comprise at least one reactive function directly bound to a connector as defined above, itself directly bound to the extractant group.

The molecule implemented during step i) can be a molecule accessible on the market or a molecule to be synthesised, by routine chemical techniques, before the implementation of the functionalisation step.

Table 1 below provides several examples of a molecule (“final compound”) usable for the functionalisation of the geopolymer and specifies the ions trapped by the extractant groups of these molecules.

TABLE 1

| | | | Example of |
|---|---|---|---|
| Reactive | | | species |
| function | Extractant group + connector | Final compound (example) | targeted |
| (RO)₃Si R = Et, Me | C₃H₆NH₂, (C₂H₄NH)ₙ, polyethylene imine | 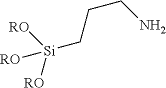 | M²⁺ (As, Ni, Pb, Cu) |
| (RO)₃Si R = Et, Me | C₃H₆PO(OAlk)(OAlk) | 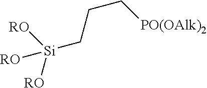 | An(IV, V, VI) (U, Pu, Th) |
| (RO)₃Si R = Et, Me | Diglycolamide function R₁, R₂ & R₃ = Alk | 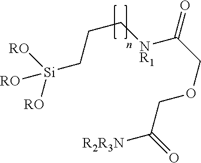 | An(III) (Am, Cm, Pu) Lanthanides |
| (RO)₃Si R = Et, Me | Ammonium function R₁, R₂ & R₃= Alk X = OH, halogen, PF₆, NTf₂ | 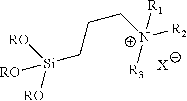 | Anions in general |
| (RO)₃Si R = Et, Me | Acetic diacid polyamine function (EDTA, DTPA) | 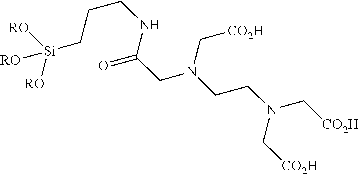 | Cations in general |
| — | Sulphate function via the activation of a sulphone | [symbol] | For cations in general |
| (RO)₃Si R = Et, Me | C₂H₄NH,—C(Alk)—PO(OAlk,Alk)(OAlk-Alk) aminophosphorus | 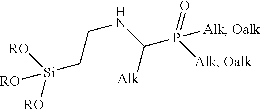 | Actinides, Lanthanides |
| (RO)₃Si R = Et, Me | C₂H₄NAlk,—CO-NAlkAlk urea | 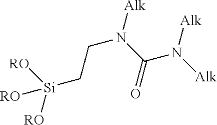 | An(IV, V, VI) (U, Pu, Th) |
| (RO)₃Si R = Et, Me | C₂H₄NAlk,—CO-Alk amide | 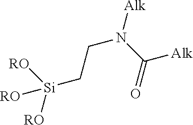 | An(IV, V, VI) (U, Pu, Th) |

The molecule, when implemented during step i), is diluted in a solvent called “grafting solvent”. Advantageously, the latter is chosen from the group consisting of the organic solvents like acetone, ethyl acetate, THF and dioxane; the alcohols like methanol, ethanol and isopropanol; the chlorinated solvents like dichloromethane and chloroform; the aliphatic solvents like the alkanes; the aromatic solvents like toluene and xylene; the supercritical fluids like supercritical CO₂ and supercritical butane and the mixtures thereof. As a specific example of mixtures, a mixture of a supercritical fluid and of an organic solvent as defined above can be mentioned.

It will be easy for a person skilled in the art to choose the most suitable solvent according to the molecule implemented as well as the quantity of the latter to be used in step i).

The conditions used during step i) allowing the attachment of the molecule to the surface of the geopolymer depend on the reactive function carried by the latter. As examples, these conditions can comprise a heat treatment and/or a stirring. This heat treatment can be a conventional treatment or via microwave heating; the temperature during this treatment is between 40° C. and 150° C. and in particular between 40° C. and 120° C. according to the boiling point of the solvent used.

Typically, step i) of the method according to the invention is between 1 h and 18 h.

Before step i) of the method according to the invention, it is possible to subject the geopolymer to a pretreatment and in particular to an acidic pretreatment. The latter allows to increase the number of “graftable” functions at the surface of the geopolymer. Once this pretreatment has been carried out, the geopolymer can be dried.

Step ii) according to the invention aims to eliminate the molecules carrying the extractant groups not having reacted with the surface of the geopolymer and in particular not being bonded, covalently, with this surface. This step ii) corresponds to a step of at least one washing.

Advantageously, step ii) of the method according to the invention comprises one (or more) washings of the surface of the geopolymer on which one or more extractant groups are immobilised, via identical or different washing solutions. In particular, step ii) of the method according to the invention comprises at least two washings, at least three washings, at least four washings or at least five washings of said surface of the geopolymer. A person skilled in the art will be able to easily define the number of washings necessary and sufficient according to the molecule and its concentration used during step i) of the method and according to the washing solution(s) used.

The washings can be carried out with an identical or different washing solution. Indeed, it is possible to use, during step ii), an identical washing solution at each washing, different washing solutions from one washing to another or identical or different washing solutions from one washing to another. The washings can have identical or different durations, these durations stretching from 1 h to 1 week and in particular approximately 48 h (48 h±2h). Step ii) of the method according to the invention is advantageously carried out under stirring and at ambient temperature.

Any washing solution known to a person skilled in the art is usable in the context of step ii) of the method according to the invention. As examples and non-exhaustively, the solvent of the washing solution implemented during step ii) of the method is chosen from the group consisting of the organic solvents like tetrahydrofuran (THF) and dioxane; the alcohols like methanol, ethanol and isopropanol; the chlorinated solvents like dichloromethane and chloroform; the aliphatic solvents like the alkanes; the aromatic solvents like toluene and xylene; the supercritical fluids like supercritical CO₂ and supercritical butane and the mixtures thereof in particular as defined above.

After the last washing of step ii) of the method according to the invention, the functionalised geopolymer obtained can be dried before any later use. Ideally, this drying is carried out at atmospheric pressure and ambient temperature or under a flow or air, for example, under a fume cupboard.

The main steps of the method for preparing the geopolymer capable of trapping at least one ion according to the invention are outlined in FIG. 1.

The present invention also relates to a geopolymer capable of trapping at least one ion prepared according to a method as defined above. Everything described above with regard to this functionalised geopolymer applies to this aspect of the invention.

Thus, the geopolymer according to the invention is in the form of a mesoporous geopolymer with optionally non-connected macropores or in the form of a foam and is functionalised, directly or indirectly, by an extractant group specific to at least one ion, the extractant group not comprising an —NH₂— amine function.

Finally, the present invention relates to the use of such a functionalised geopolymer to separate at least one ion such as a metal or metalloid ion from a flow containing said at least one ion such as a metal or metalloid ion.

Thus, the present invention relates to a method for separating at least one ion such as a metal or metalloid ion from a flow containing said at least one ion such as a metal or metalloid ion involving placing the flow containing said at least one ion such as a metal or metalloid ion in contact with the functionalised geopolymer according to the invention, whereby a flow depleted of ions such as metal or metalloid ions and a geopolymer at the surface of which ions such as metal or metalloid ions are fixed via the extractant groups present at this surface are obtained.

In other words, the method according to the invention can be considered a method for treating a flow containing at least one ion such as a metal or metalloid ion. “Treatment of a flow containing at least one ion such as a metal or metalloid ion” means reducing the quantity of ions such as metal or metalloid ions, present in the flow before the implementation of the method according to the invention i.e. before the placement in contact with the functioned geopolymer. This reduction can involve the partial or total elimination of these ions in the flow. This aspect is also outlined in FIG. 1.

Indeed, the excellent properties of mechanical strength and stability of the functionalised geopolymer prepared by the method according to the invention resulting from its specific structure allow its conditioning in a column and the continuous implementation of the separation/fixation method, for example in a fluidised bed, which can thus be easily integrated into an existing facility, for example in a treatment chain or line comprising several steps.

After the separation method according to the invention, the elements located in the flow to be treated, such as anions or cations, are immobilised, in the functionalised geopolymer according to the invention, by adsorption, by chelation or by complexation via the extractant groups themselves bound to the surface of the geopolymer, this bond advantageously being covalent.

“Flow containing at least one ion such as a metal or metalloid ion” means a liquid or gaseous flow in which the present invention aims to separate, recover or eliminate undesired ions such as metal or metalloid ions or, on the contrary, ions such as metal or metalloid ions of interest. Thus, the flow implemented in the context of the present invention can be any liquid or gaseous flow capable of containing at least one ion such as a metal or metalloid ion.

Advantageously, the flow containing at least one ion such as a metal or metalloid ion implemented in the invention is a liquid flow. The latter can be in the form of a single-phase solution, a micro-emulsion, a suspension and/or a dispersion. The liquid flow implemented can be an aqueous solution that can optionally contain acids, bases or organic compounds. Alternatively, this solution can also be a solution in an organic solvent such as aliphatic compounds like alkanes or alkenes, aliphatic or non-aliphatic alcohols, active molecules such as, for example, surfactants or extractants, in a mixture of these organic solvents, or in a mixture of water and of one or more of these organic solvents. This solution can further comprise active molecules like surfactants such as, for example, octanol, sodium dodecylsulphate (SDS) or cetyltrimethylammonium bromide (CTAB) or extractants such as, for example, aliphatic amines, derivatives of organic phosphates and amides.

As examples, the liquid or gaseous flow implemented in the context of the present invention can be chosen from the group consisting of an outside air sample, an air sample coming from industries of the chemical, agri-food, pharmaceutical, cosmetic or nuclear field, municipal water, river water, seawater, lake water, an effluent coming from a wastewater treatment plant, wastewater, a household liquid effluent, a medical or hospital liquid effluent, an industrial liquid effluent, like an effluent coming from the nuclear industry or from any other activity linked to the nuclear industry or an effluent coming from the non-nuclear industry, and one of the mixtures thereof.

The various liquids and effluents of the nuclear industry, of nuclear facilities and of the activities implementing radionuclides that can be treated by the functionalised geopolymer prepared by the method according to the invention include, for example, the cooling water of power plants, and all the various effluents coming in contact with radio-isotopes such as all the washing water, the solutions for regeneration of resins or the organic effluents coming from the activities of research and development.

The various liquids and effluents of the non-nuclear industry include the cement-plant effluents containing thallium which is a violent poison or the effluents of the paper industry.

Thus, the flows and solutions that can be treated with the functionalised geopolymer fixing ions such as metal or metalloid ions prepared by the method according to the invention are very varied, and can even contain, for example, extractant agents that are competitors, corrosive, or other, because of the excellent chemical stability of the geopolymer according to the invention. The functionalised geopolymer prepared by the method according to the invention is usable in particular over a very large pH range going, for example, from a neutral pH up to a pH of 10.

Typically, via a suitable choice of the extractant groups at its surface, the functionalised geopolymer according to the invention can be used to fix, chelate, complex or trap any given ion. “lon” means either a cation or an anion, whether the latter are impurities, contaminants or cations or anions of interest capable of being recycled like, for example, lithium.

In a specific embodiment, the ion fixed, chelated, complexed or trapped by a functionalised geopolymer according to the invention is a metal or metalloid ion.

“Metal or metalloid ion” means, in the context of the present invention, an undesired metal or metalloid ion such as an impurity or a contaminant or, on the contrary, a metal or metalloid ion of interest, capable of being present or present in a flow as defined above. This metal or metalloid ion can, furthermore, be toxic, harmful and/or radioactive.

The present invention can be implemented with any metal or metalloid ion known to a person skilled in the art. Advantageously, the metal ion is an ion of a poor metal, an ion of an alkaline-earth metal, an ion of a transition metal, an ion of an actinide or an ion of a lanthanide. The metal or metalloid ions to which the present invention relates also include the ions of a heavy metal or of a heavy metalloid. As a reminder, a heavy metal or metalloid is a metal or metalloid element, the density of which exceeds 5 g/cm³ such as mercury, lead, cadmium, copper, arsenic, nickel, zinc, cobalt and manganese.

Advantageously, the metal or metalloid ion, in the context of the present invention, is an ion of a metal or a metalloid as defined above having a degree of oxidation greater than or equal to 1, in particular greater than or equal to 2. The metal or metalloid ion can in particular be an ion of a radionuclide.

As illustrative examples, the metal or metalloid ion can be, in the context of the present invention, an ion of an element chosen from mercury, gold, silver, platinum, lead, iron, indium, gallium, aluminium, bismuth, tin, cadmium, copper, lithium, arsenic, nickel, zinc, titanium, cobalt, manganese, palladium, curium, americium, radium, ruthenium, thorium, uranium, plutonium, actinium, ytterbium, erbium, terbium, gadolinium, europium, neodymium, praseodymium, cerium, caesium, thallium, strontium and lanthanum.

In the context of the present invention, the ion such as a metal or metalloid ion can be in free form or in the form of colloids or in complexed form. In the context of a metal or metalloid ion, the latter can come from a stable metal or metalloid or from one of its radioactive isotopes.

The ion such as a metal or metalloid ion can be present in the flow to be treated in a very diluted or much more concentrated form. Thus, the quantity of said ion in a liquid flow to be treated can be between 1 pg and 100 mg/l of liquid flow, in particular between 1 μg and 10 mg/l of liquid flow and, in particular, between 10 μg and 1 mg/l of liquid flow.

Typically, the separation method that implements the functionalised geopolymer subject-matter of the present invention is implemented continuously, in particular while using this geopolymer in the form of particles and conditioned for example in column form, the geopolymer thus forming a fluidised bed, the fluidisation of which is ensured by the flow to be treated. Alternatively, the separation method can also be implemented discontinuously, in “batch” mode, the placement of the geopolymer and of the flow to be treated in contact thus being advantageously carried out under stirring. The conditioning in a column allows to continuously treat significant quantities of flow, with a strong flow rate of the latter.

The time of contact of the flow to be treated with the functionalised geopolymer forming the object of the present invention is variable and can range, for example, from 1 min to 1 h for continuous operation and, for example, from 10 min to 36 h and, for example, be of 24 h for “batch” operation.

Moreover, since the functionalised geopolymer can be in the form of monoliths, it can be used as a conditioning material trapping the elements contained in this conditioning and capable of flowing out of the latter.

Other features and advantages of the present invention will also appear to a person skilled in the art upon reading the examples below given for illustrative and non-limiting purposes, in reference to the appended drawings.

### BRIEF DESCRIPTION OF THE DRAWINGS

FIG. 1 is a diagram of the main steps of the method for preparing a geopolymer capable of trapping at least one ion and its use in the decontamination of a liquid effluent containing said at least one ion.

FIG. 2 presents photographs of the material obtained during the various steps allowing the creation of a geopolymer with controlled porosity. The sample presented has a theoretical porosity of approximately 25% by volume.

FIG. 3 presents photographs following, in time, the step allowing the creation of a geopolymer with controlled porosity (the sample presented has a theoretical porosity of approximately 25% by volume).

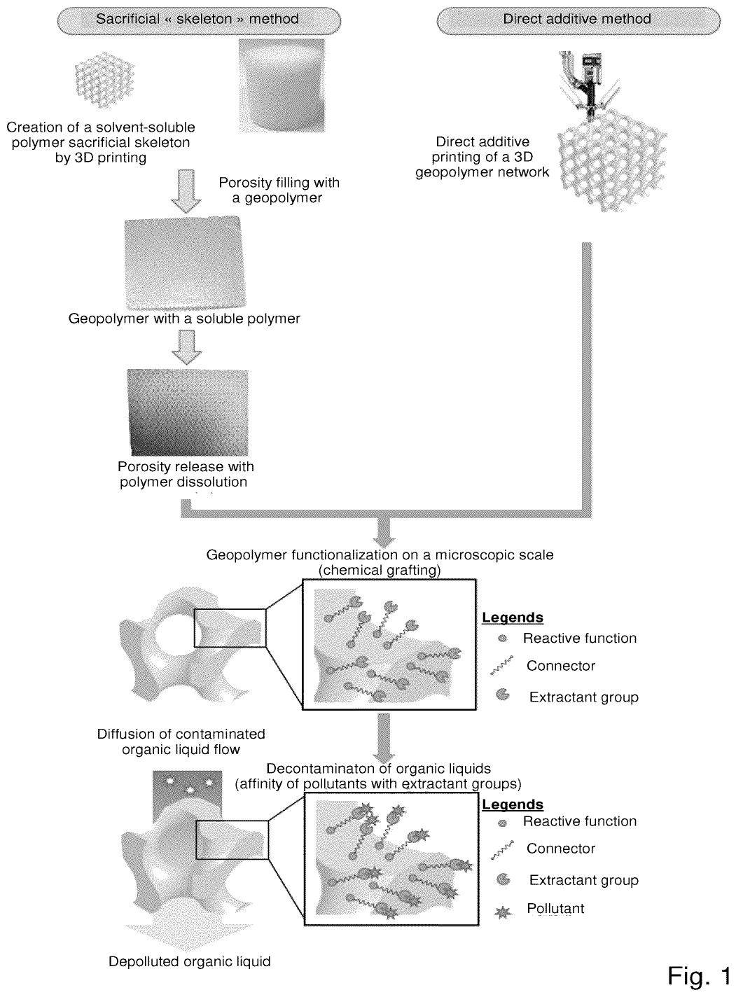

### DETAILED DISCLOSURE OF SPECIFIC EMBODIMENTS

### I. Method for Preparing a Geopolymer with Controlled Porosity

### I.1Method by Direct 3D Printing

Step 0: Modelling of the percolating network on a computer, the geometry of filling of the part is chosen to correspond to a complex geometry.

Step 1: Printing of the part on a fused deposition modelling 3D printer (of the FDM type), the filament chosen is a geopolymer formulation corresponding to the following formula expressed in moles: 3.8 SiO₂: 1.0Al₂O₃: 1.0Na₂O: 11.0H₂O. The printing parameters are:
Layer height: 0.5 mm;
Size of the nozzle: 0.8 mm;
Type of filling: gyroid;
Filling rate: 20 to 80%;
No heating of the bed or of the nozzle, the technique amounting to a deposition of geopolymer paste in the fresh state.

### I.2. Method by Inverse 3D Printing

The protocol followed to create a geopolymer via inverse 3D printing is the following:
Step 0: Modelling of the sacrificial backbone on a computer, the geometry of filling of the part is chosen to correspond to a complex geometry.
Step 1: Printing of the part on a fused deposition modelling 3D printer (of the FDM type), the filament chosen is HIPS. The printing parameters are a temperature of 240° C. for the nozzle and 110° C. for the print bed.
Step 2: i. Formulation of a geopolymer mixture, which involves mixing an activation solution and metakaolin in the following proportions corresponding to the formulation expressed in moles: 3.8 SiO₂: 1.0Al₂O₃: 1.0Na₂O: 11.0H₂O. To do this, 54.2 g of BETOL 52T (aluminosilicate source), 0.5 g of water, 2 g of NaOH and 43.3 g of IMERYS M1000 metakaolin are used.

Then, the whole is placed under stirring in order to guarantee the homogeneity of the geopolymer paste.

ii. Immersion of the polymer sacrificial backbone in the latter. The sample is then placed under ultrasounds for 30 seconds, in order to remove the residual air bubbles in the geopolymer. Other techniques can be used such as placement under vacuum to remove the residual air bubbles, or the arrangement of a specific mould that would allow to push the paste into the sacrificial backbone (i.e. a suitable syringe).
Step 3: This step involves allowing the composite material (geopolymer comprising the sacrificial backbone) harden for 7 days, which allows the geopolymer to develop sufficient mechanical strength for the following step. A surface preparation of the sample is necessary in order to expose the surface of the sacrificial backbone: the two ends of the geofilter are sectioned with a circular or wire saw to expose the channels of the sacrificial backbone.
Step 4: Freeing the porosity by dissolution of the polymer (HIPS) present in the material. For this, the material is immersed in dichloromethane under stirring, it is left until stabilisation of its mass. The material thus prepared has a controlled porosity.

Once dried (oven or under air, at a temperature between ambient temperature and 30° C., for a duration between 2 h and 4h), the material is thus ready for the following step of the method (grafting).

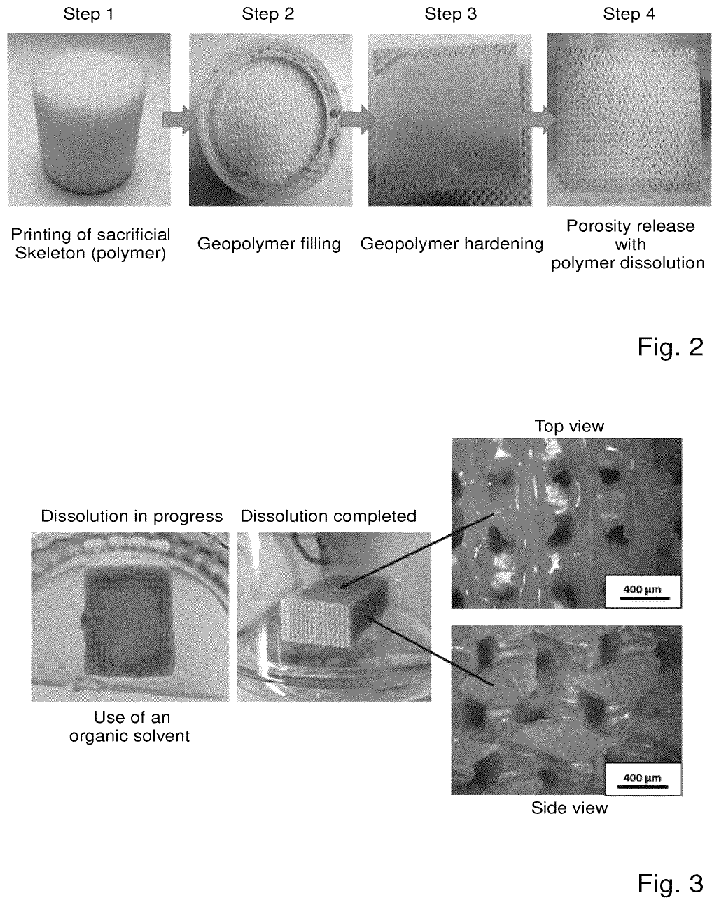

Steps 1 to 4 are illustrated in FIG. 2 in the case of a geopolymer with 25% porosity by volume relative to the total volume (75% of volume occupied by the geopolymer). The photograph of step 1 corresponds to the sacrificial backbone made of HIPS obtained by 3D printing. The photograph of step 2 corresponds to the filling by geopolymer matrix. The photograph of step 3 taken after hardening of the geopolymer corresponds to a transverse cross-section of the material obtained, allowing to view the encapsulation of the sacrificial backbone in the latter. The photograph of step 4 taken after freeing of the porosity after the dissolution of the sacrificial backbone made of polymer corresponds to a transverse cross-section of the geopolymer obtained, allowing to view the porosity of the latter corresponding to the location of the sacrificial backbone.

FIG. 3 addresses the step 4 of dissolution of the sacrificial backbone made of HIPS, a complex and controlled geometry can be observed inside the material.

### II. Method for Functionalisation of this Geopolymer with Controlled Porosity

The grafting steps are carried out after the step of freeing the porosity.

The step 0 of pretreatment is optional. However, the step 4 of “freeing the porosity” of the process “Preparation of a geopolymer with controlled porosity” can be carried out simultaneously with the step 2 of grafting in the absence of step 0.

Step 0: Acid pretreatment of the geopolymer filter then drying.

Immersion of the filter in suspension in a 0.1 M solution of nitric acid at ambient temperature under slight stirring without contact between the stirring mechanism and the filter.

Immersion of the filter in suspension in a solution of toluene at ambient temperature under slight stirring without contact between the stirring mechanism and the filter.
Step 1: The grafting reactant used is the [3-(diethylamino) propyl] trimethoxysilane having the CAS: 41051-80-3 and the formula:

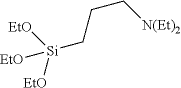

Step 2: Grafting of the extractant groups onto the geopolymer by placement in contact and heating of the latter with the grafting reactant in dichloromethane with reflux (40° C.) for one night (1 mmol of grafting reactant/g of geofilter/10 ml of solvent).
Step 3: Washing of the residual impurities using repeated washings in dichloromethane in Soxhlet equipment (150 ml of solvent with reflux for one night on a filter placed in a cellulose cartridge).
Step 4: Drying of the sample in an oven (80° C., one night) the material is then ready to be analysed.

### III. Characterisation of the Functionalised Geopolymer Obtained

It is possible to characterise the geopolymer obtained by the method according to the invention via various techniques. Examples of such techniques include gravimetry, porosimetry (gas, mercury), nuclear magnetic resonance like MAS-NMR (Magic Angle Spinning-NMR), infrared spectroscopy like Fourier-transform infra-red spectroscopy (or FTIR) and DSC (for Differential Scanning calorimetry) coupled with thermogravimetric analysis.

Table 2 below presents the characterisations after grafting in the case of a geopolymer with 25% porosity by volume, functionalised by the grafting reactant: 3-(diethylamino)propyl]trimethoxysilane, for which the reactant function is trimethoxy silane and the extractant group with a connector is diethylpropyl amine.

This extractant group can be intended for the extraction of actinides (uranium) from organic solutions, but also be used in the depollution of water of transition metals/metalloids (for example, arsenic, lead, copper, cadmium).

The overall taking on of mass, coupled with the appearance of the MAS-NMR signals (analysis of the NMR signals obtained directly by analysis of the solid) on the ¹³C spectra typical of the alkyl chains bound to the amine as well as the reduction in specific surface area (linked to the covering of the surface by the organic functions), confirms the functionalisation by grafting of the porous geopolymer manufactured by inverse 3D.

TABLE 2
Characterisation proving the functionalisation
of a geopolymer with controlled porosity

| | Initial | Final |
|---|---|---|
| | characteristics | characteristics |
| Mass (g) | 6.595 | 6.815 (3.2% |
| | | mass taken on) |
| TGA (thermogravimetric | 13.4% | 13.6% |
| analysis) % mass loss | | |
| MAS-NMR (²⁹Si) | ²⁹Si: −87.9 | ²⁹Si: −60.6 −87.2 |
| MAS-NMR (¹³C) | ¹³C: 168.8, 166.7, | ¹³C: 170.8, 144.9, 127.9, |
| | 127.6, 45.0, | 57.6, 47.5, 22.6, 11.3 |
| | 41.6, 28.3 | In bold: high-intensity |
| | | peaks typical of grafted |
| | | (CH₂)₃N(CH₂CH₃)₂ |
| | | carbons |

### BIBLIOGRAPHICAL REFERENCES

[1] Steins et al, 2014, “Effect of aging and alkali activator on the porous structure of a geopolymer”, Journal of Applied Crystallography, vol. 47, pages 316-324.
[2] Lee et al, 2017, “Adsorption characteristics of cesium onto mesoporous geopolymers containing nano-crystalline zeolites”, Microporous and Mesoporous Materials, vol. 242, pages 238-244.
[3] Luukkonen et al, 2020, “Ag- or Cu-modified geopolymer filters for water treatment manufactured by 3D printing, direct foaming, or granulation”, Scientific Reports, vol. 10, pages 1-14.
[4] Cepollaro et al, 2021, “Cu-exchanged 3D-printed geopolymer/ZSM-5 monolith for selective catalytic reduction of NOx”, Chemical Engineering Transactions, vol. 84, pages 67-72.

1. A method for preparing a geopolymer capable of ion trapping, the method comprising:
preparing a geopolymer comprising 3D printing, to obtain a prepared geopolymer; and
functionalizing the prepared geopolymer with a functionalization comprising an extractant group specific to an ion,
wherein the extractant group does not have an —NH₂ amine function.

2. The method of claim 1, wherein the geopolymer is mesoporous.

3. Method according to claim 1, wherein the geopolymer is a foam.

4. The method of claim 1, wherein the extractant group comprises:
an ammonium of formula —N(R₁) (R₂) (R₃) with R₁, R₂, and R₃, independently being H, an alkyl radical, or an aryl radical;
an amine of formula —N(R₄)(R₅) with R₄ and R₅ independently being H, an alkyl radical, or an aryl radical, provided that, when R₄ is H, R₅ is not H;
an amide of formula —C(═O)—N(R₆) (R₇) or -N(R₆)C(═O)-(R₇) with R₆ and R₇ independently being H, an alkyl radical, or an aryl radical;
a phosphorus function of formula X₂-P(-X₁)ₙ(X₃R₈)(X+R₉) with n being 0 or 1, X₁ being O or S, X₂, X₃, and X₄, independently being a chemical bond, O, S, or a -CR₁₀R₁₁- group, R₈ and R₉ independently being H, an alkyl radical, or an aryl radical, and R₁₀ and R₁₁ independently being H or an alkyl radical;
a diglycolamide of formula —N(R₁₂)—C(═O)—CH₂—O—CH₂—C(O)—N(R₁₃)(R₁₄) with R₁₂, R₁₃, and R₁₄ independently being an alkyl radical or an aryl radical;
an amine or polyamine of formula -[N(CH₂COOH)-C₂H₄]ₘ—N(CH₂—COOH)₂ with m being 0 or an integer;
a sulfonic acid of formula -(CH₂)ₚ(SO₃H) with p being 0 or an integer;
a urea of formula —NR₁₅—C(═O)—N(R₁₆) (R₁₇) with R₁₅, R₁₆, and R₁₇ independently being H, an alkyl radical, or an aryl radical; and/or
a macromolecular or polydentate function.

5. The method of claim 1, wherein the functionalization of the geopolymer by at least one-the extractant group is direct.

6. The method of claim 1, wherein the functionalization of the geopolymer by the extractant group is indirect, comprising a connector bound, on a first side, to a surface of the geopolymer and, on a second side, to the extractant group.

7. The method of claim 1, geopolymer wherein the preparing comprises:
(a1) preparing a geopolymer mixture;
(b1) 3D printing the geopolymer mixture from the preparing (a1), to obtain a printed geopolymer; and
(c1) allowing the printed geopolymer from the 3D printing (b1) to harden, thereby obtaining a geopolymer.

8. The method of claim 1, wherein the preparing comprises:
(a2) preparing, by 3D printing, a sacrificial support;
(b2) placing the sacrificial support from the preparing (a2) in contact with a previously prepared geopolymer mixture, to obtain a contacted geopolymer mixture;
(c2) allowing the contacted geopolymer mixture to harden in contact with the sacrificial support; and
(d2) eliminating the sacrificial support, thereby obtaining a geopolymer.

9. The method of claim 1, wherein the functionalization comprises:
(i) placing the geopolymer in contact with a molecule comprising the extractant group and a reactive function in conditions allowing at least one covalent bond to form between the molecule and the geopolymer, to obtain a reacted geopolymer; and
(ii) eliminating said unreacted molecule from the placing (i), thereby obtaining a functionalized geopolymer comprising the extractant group.

10. A geopolymer capable of trapping at least one ion, the geopolymer prepared by the method of claim 1,
wherein the geopolymer is mesoporous with optionally non-connected macropores or a foam and is functionalized, directly or indirectly, by an extractant group specific to at least one ion, and
wherein the extractant group does not comprise an —NH₂— amine function.

11. A method for ion separation from a flow, the method comprising:
contacting a first flow comprising an ion and the geopolymer of claim 10, thereby separating the ion from the first flow to obtain a second flow, comprising the ion in a lesser amount, and a laden geopolymer comprising the ion affixed via the extractant group to a surfaces of the laden geopolymer.

12. The method of claim 11, wherein the flow is an outside air sample, an air sample coming from industries of the chemical, agri-food, pharmaceutical, cosmetic or nuclear field, municipal water, river water, seawater, lake water, an effluent coming from a wastewater treatment plant, wastewater, a household liquid effluent, a medical or hospital liquid effluent, an industrial liquid effluent, or a mixture thereof.

13. The method of claim 11, wherein the ion is a metal or metalloid ion.

14. The method of claim 13, wherein the metal or metalloid ion comprises mercury, gold, silver, platinum, lead, iron, indium, gallium, aluminium, bismuth, tin, cadmium, copper, lithium, arsenic, nickel, zinc, titanium, cobalt, manganese, palladium, curium, americium, radium, ruthenium, thorium, uranium, plutonium, actinium, ytterbium, erbium, terbium, gadolinium, europium, neodymium, praseodymium, cerium, cacsium, thallium, strontium, and/or lanthanum.

15. The method of claim 1, wherein the extractant group comprises:
a crown ether, a thioether crown, a calixarene, a porphyrin, a phthalocyanine, a pyrazoline, a phenanthroline, an ethylenediaminetriacetic acid, an ethylenediaminetetraacetic acid (EDTA), a 1,4,7,10 tetraazacyclododecane 1,4,7,10 tetraacetate (DOTA), and/or a diethylene triamine pentaacetate (DTPA).

16. The method of claim 1, wherein the geopolymer is mesoporous with non-connected macropores.

17. The method of claim 1, wherein the extractant group comprises the polyamine of formula -[N(CH₂COOH)—C₂H₄]ₘ—N(CH₂—COOH)₂ with m being 1, 2, 3, or 4.

18. The method of claim 1, wherein the extractant group comprises the sulfonic acid of formula -(CH₂)ₚ(SO₃H) with p being 1, 2, 3, 4, or 5.
